(19) United States
(12) Patent Application Publication
(10) Pub. No.: US 2024/0338032 A1
(43) Pub. Date: Oct. 10, 2024

(54) GENERAL PRE-TRAINED TRANSFORMER SERVICE FOR A GENERAL-PURPOSE ROBOTICS OPERATING SYSTEM

(71) Applicant: Perrone Robotics, Inc., Charlottesville, VA (US)

(72) Inventor: Paul J. Perrone, Crozet, VA (US)

(73) Assignee: Perrone Robotics, Inc., Charlottesville, VA (US)

(21) Appl. No.: 18/627,663

(22) Filed: Apr. 5, 2024

Related U.S. Application Data
(60) Provisional application No. 63/457,239, filed on Apr. 5, 2023.

(51) Int. Cl. G05D 1/60; G05D 101/15; G06N 3/0475

(52) U.S. Cl. CPC G05D 1/60; G06N 3/0475; G05D 2101/15

(57) ABSTRACT

Provided herein are system, apparatus, article of manufacture, method and/or computer program product aspects, and/or combinations and sub-combinations thereof, for artificial intelligence in mobile autonomous robotics and autonomous mobile platforms. An example aspect operates by a method of using a general-purpose robotics operating system (GPROS) with generative pre-trained transformers (GPT) (GPROS-GPT) model. The method includes training the GPROS-GPT model and querying the GPROS-GPT model to generate GPROS configuration data and service extension files. The method further includes loading the configuration data and the service extension files into a GPROS-based application and using the GPROS-based application to operate a GPROS-based robot or a GPROS-based autonomous vehicle.

### CROSS-REFERENCE TO RELATED APPLICATIONS

This application claims priority to U.S. Provisional Patent Application No. 63/457,239, filed on Apr. 5, 2023, which is hereby incorporated by reference in its entirety.

### BACKGROUND

### Field

The present disclosure generally relates to artificial intelligence in mobile autonomous robotics and autonomous mobile platforms.

### SUMMARY

Provided herein are system, apparatus, article of manufacture, method and/or computer program product aspects, and/or combinations and sub-combinations thereof, for artificial intelligence in mobile autonomous robotics and autonomous mobile platforms.

Some aspects relate to a general pre-trained transformer artificial intelligence application service for a general-purpose robotics platform. This service can be used to provide an expansive set of new configurations and extensions for robotic sensors, behavior, controls, and communications based on simple expressions of desired output while leveraging an extensive database of knowledge from a general pre-trained transformer. The general pre-trained transformer combined with the general-purpose robotics operating system enables rapid specification of new application services for robots which further enables a massive amount of intelligence and new behaviors to be specified and embodied inside of such robots. The large body of intelligence incorporated into such robots enables highly robust and reliable mobile autonomous robotics which further accelerates the practical deployment and proliferation of autonomous robotics. Furthermore, combined with a safety and security watchdog service, a provably safe and secure method of mobile autonomous robotics is enabled that is also massively robust against unsafe failure modes and malicious attacks. The disclosure generally applies to robotics mobility platforms operating on the ground, in the air, on water or underwater, or in space.

An example aspect operates by a method of using a general-purpose robotics operating system (GPROS) with generative pre-trained transformers (GPT) (GPROS-GPT) model. The method includes training the GPROS-GPT model and querying the GPROS-GPT model to generate GPROS configuration data and service extension files. The method further includes loading the configuration data and the service extension files into a GPROS-based application and using the GPROS-based application to operate a GPROS-based robot or a GPROS-based autonomous vehicle.

An example aspect operates by a non-transitory computer-readable medium storing instructions that, when executed by a processor, cause the processor to perform operations. The operations can include training the GPROS-GPT model and querying the GPROS-GPT model to generate GPROS configuration data and service extension files. The operations further include loading the configuration data and the service extension files into a GPROS-based application and using the GPROS-based application to operate a GPROS-based robot or a GPROS-based autonomous vehicle.

An example aspect operates by a system including one or more memories and at least one processor each coupled to at least one of the memories. The at least one processor is configured to train the GPROS-GPT model and query the GPROS-GPT model to generate GPROS configuration data and service extension files. The at least one processor is further configured to load the configuration data and the service extension files into a GPROS-based application and use the GPROS-based application to operate a GPROS-based robot or a GPROS-based autonomous vehicle.

### BRIEF DESCRIPTION OF THE DRAWINGS/FIGURES

The accompanying drawings are incorporated herein and form a part of the specification.

FIG. 1 illustrates a block diagram of a robot with a general-purpose robotics operating system (GPROS) and configuration, according to some aspects.

FIG. 2 illustrates a block diagram of GPROS application service configuration, according to some aspects.

FIG. 3 illustrates an exemplary configurable implementations, according to some aspects.

FIG. 4 illustrates a block diagram of application service inheritance, according to some aspects.

FIG. 5 illustrates a GPROS-GPT illustrative overview, according to some aspects.

FIG. 6 illustrates a GPROS-GPT input data and model, according to some aspects.

FIG. 7 illustrates another GPROS-GPT input data and model, according to some aspects.

FIG. 8 illustrates one exemplary method for using the GPROS-GPT, according, according to some aspects.

FIG. 9 illustrates an example computer system that can be used for implementing various aspects.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, article of manufacture, method and/or computer program product aspects, and/or combinations and sub-combinations thereof, for artificial intelligence in mobile autonomous robotics and autonomous mobile platforms.

A general-purpose robotics operating system (GPROS) can include unmanned and autonomous vehicle extensions as discussed in, for example, U.S. Pat. Nos. 9,195,233, 9,833,901, 10,331,136, and 11,314,251, all of which are incorporated by reference herein in their entireties.

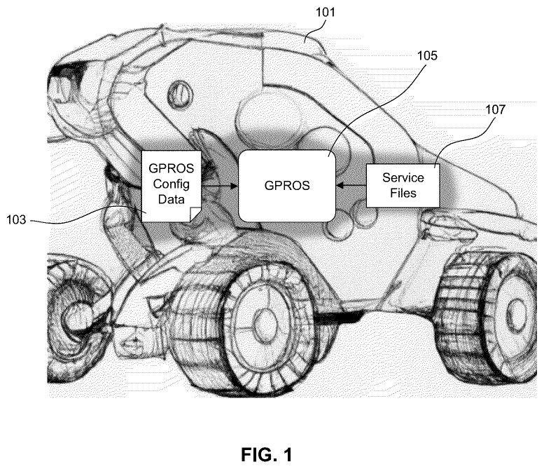

FIG. 1 illustrates a block diagram of a robot 101 with a GPROS and configuration data, according to some aspects. The GPROS 105 provides applications services for robotics and automation applications that can be configured using configuration services. Such services (e.g., service files 107) provide a method by which configuration data (e.g., GPROS config data 103) may be loaded, transparent to the application, from one or more configuration data sources in both a static fashion (i.e., at application startup) or dynamically (i.e., as the application is running). Thus, data stored in files, be it XML data or other data formats, is loaded and used by robotics applications services. Since robotics application services can control the behavior and operation of a robot (e.g., robot 101), this generated config data for such services can likewise alter the behavior and operation of the robot. The GPROS 105 can also define an approach for automatic assembly and construction of applications based on configuration data. Thus, alternate code modules (i.e. “service extensions”) can be loaded based on data stored in configuration files. These alternate service extensions can also alter the behavior and operation of the robot 101.

A GPROS (e.g., GPROS 105) has configurable application services with configuration files that can define sensing, controls, communications, and behavior services for a robot. Thus, what sensors to be used and how they process data can be defined with configuration data (e.g., GPROS config data 103) from configuration services. For example, whether to load connectivity to a GPS system from vendor A or vendor B, and how to process that data can be defined in configuration files feeding the GPROS 105. The controls to be used and how they interpret commanded data into control actions can be defined with configuration data (e.g., GPROS config data 103) from configuration services. For example, the configuration of closed loop controls for a steering motor on an autonomous vehicle and the limits of steering can be defined in configuration files feeding the GPROS 105. The communications devices to be used and the protocols for communication can also be defined with configuration data from configuration services. For example, the configuration of a TCP-IP based communications interface and the message formats to be communicated can be defined in configuration files feeding the GPROS 105.

Significantly, the robot behaviors to be employed and the parameters of behavior can be defined with configuration data (e.g., GPROS config data 103) from configuration services. Behaviors may include, for example, perception, movement planning, path planning, safety checking, and cybersecurity checking services. Further examples of each are listed here:
a. Configuration of a Light Detection and Ranging (LiDAR) perception service that translates raw point cloud data from a LiDAR into detected and identified objects in the world (e.g. pedestrians, cars, dogs).
b. Configuration of a movement planning service that defines a new crosswalk maneuver which is activated when a crosswalk is identified when the robotic vehicle is within distance on a map, and a sequence of actions configured for sequencing through the behaviors of approaching, navigating through, and exiting past the crosswalk. Inclusive of further configured behaviors to define are parameters such as minimum speeds of travel and distance buffers to maintain between the robotic vehicle and identified objects.
c. Configuration of path planning services to identify the traversal of a robot according to a spline path plan and the parameters which define the width and arc of such paths.
d. Configuration of safety checking services which define safety checks to perform and the parameters of such checks. Such as the definition to ensure that two independently read speed values lie within some minimum error value, otherwise a failed safety check is flagged.
e. Configuration of cybersecurity checking services which define security checks to perform and the parameters of such checks. Such as the definition to ensure that only a service with an authorized signature is allowed to issue an acceleration command to a control service in the robot.

However, the aspects of this disclosure are not limited to these examples.

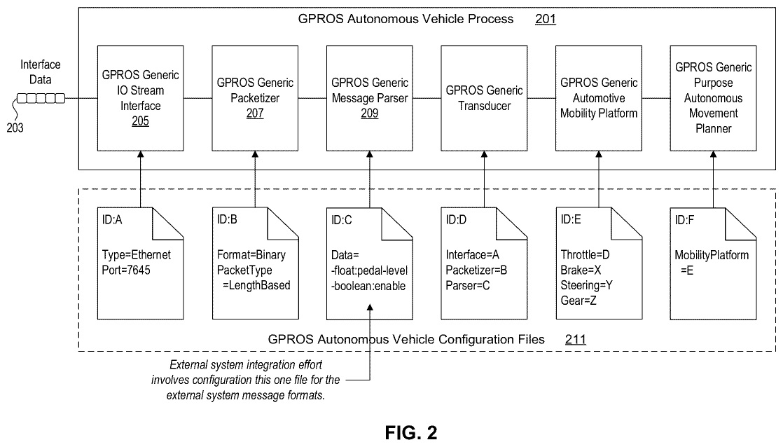

An illustration of the comprehensiveness of such configurable services is shown in FIG. 2, which illustrates a block diagram of GPROS application service configuration, according to some aspects. Here a GPROS service 201 (e.g., a GPROS autonomous vehicle process 201) is configured to stream data 203 from an Ethernet interface 205 on a specified port, told to packetize (e.g., using a packetizer service 207) the inbound binary data based on embedded length information, and then to parse (e.g., using a parser service 209) the data according to parse instructions such as parsing pedal input levels as floating point numbers. At a higher level, GPROS service 201 indicates which interface 205, packetizer service 207, and parser service 209 to use which provides configurable flexibility in choosing different ways to interpret data. The GPROS service 201 also indicates which control points to load such as throttle, brake, steering, and gear shifting for an automotive mobility platform. And at the highest level, the GPROS service 201 selects this form of mobility platform service for use in controlling the mobile robot. The GPROS configuration service (e.g., GPROS configuration files 211 such as GPROS autonomous vehicle configuration files) thus allows the ability to not only change the behavior of an aspect of a robotics platform by modifying configuration data but also allows references to alternate behaviors to be changed which enables new and alternate behaviors to be loaded statically or dynamically.

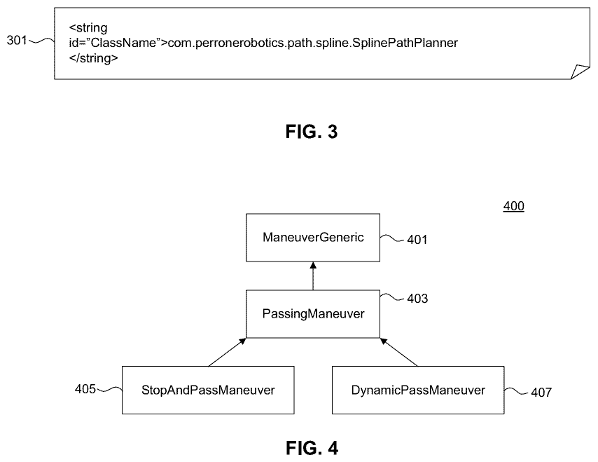

The GPROS can also allow for configuration of an entirely different implementation algorithm to be loaded for a particular identified application service by way of referencing an implementation to load. As depicted in FIG. 3, an example SplinePathPlanner implementation 301 can be loaded in an application service's configuration. However, an alternate path planner implementation algorithm could be loaded by specifying a different named implementation in the configuration file.

Such a GPROS thus has configurable application services with configuration files that define robotics aspects such as sensing, behavior, controls, and communications services. The behaviors further have robotics aspects such as perception, movement planning, path planning, safety checking, and cybersecurity checking services. As an example implementation, references and behavior of such applications services may be defined in configuration data or files. Furthermore, each of the application services built into GPROS have a generic structure that is configurable, which allow different configurable behavior. Extensions of such generic application services via inheritance structures allow for explicit coding of operations to provide more specific and extended behaviors. FIG. 4 illustrates a block diagram of application service inheritance 400, according to some aspects. As exemplified in the simple UML inheritance diagram of FIG. 4, GPROS ManeuverGeneric 401, which can be a generic representation of an autonomous maneuver, can be extended via inheritance to implement a vehicle passing maneuver (PassingManeuver) 403, which in turn can be extended via inheritance to implement a passing maneuver that stops before passing a vehicle (StopAndPassManeuver 405) and a passing maneuver that passes another vehicle dynamically in motion without stopping (DynamicPassManeuver 407).

Generative pre-trained transformers (GPT) is an artificial intelligence (AI) methodology for generating content from natural language based descriptions. GPTs are a type of deep learning artificial intelligence (AI) model that uses a transformer architecture that can generate human readable text. These models can be trained on massive amounts of data, such as books, articles, and web pages, using unsupervised AI learning techniques. By analyzing the patterns in the language, the model can generate coherent and diverse text in a variety of styles and genres. GPT models have been used for a wide range of natural language processing tasks, such as language translation, text completion, and chatbot generation. GPTs have also been used to generate source code in popular programming languages that implement certain functions based on natural language descriptions of such desired output. Additionally, or alternatively, the GPTs can be trained on data other than text data. For example, the GPTs can be trained on, and use, raw sensor data that can include image data, video data, Light Detection and Ranging (LiDAR) point cloud data, Radio Detection And Ranging (RADAR) data, and other forms of sensory information.

The present disclosure generally relates to the combination of a GPT with a GPROS (GPROS-GPT). The GRPOS-GPT is a method for generating configurations and service extensions for use by a GPROS based on natural language-based descriptions. Thus, new configurations and service extensions of sensing, perception, movement planning, path planning, safety checking, cybersecurity checking, controls, and communications services, among other GPROS application services, can be created rapidly based on natural language descriptions. The GPROS-GPT method enable rapid and extensive development of robust robotics and autonomous vehicle applications. Given that GRPOS-GPT can also generate configurations and service extensions for GPROS safety and cybersecurity application services, this disclosure further enables rapid development of comprehensively complete safe and secure robotics and autonomous vehicle applications which can be independently verified and validated.

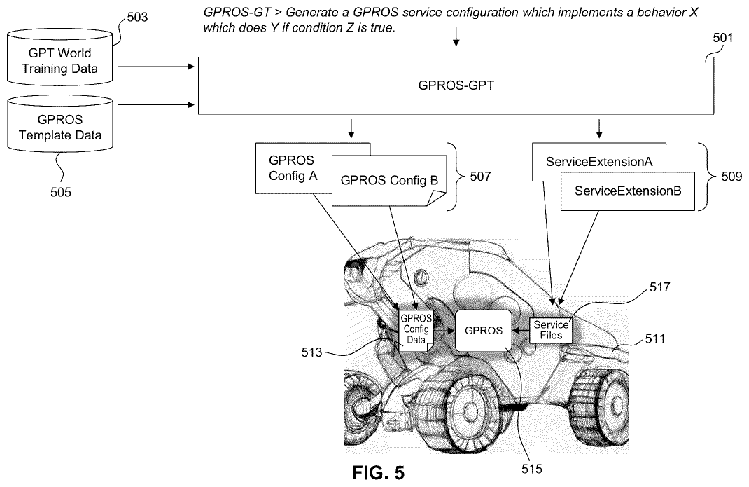

FIG. 5 illustrates a GPROS-GPT illustrative overview, according to some aspects. As illustrated in FIG. 5, a GPROS-GPT model 501 takes in training data 503 about the world in general for GPT-based intelligence and also from specialized knowledge about GPROS application service configuration and service extension templates 505. Given a natural language request to GPROS-GPT referencing GPROS application services and constructs, the GPROS-GPT then generates GPROS configuration data 507. The GPROS-GPT may also generate new application service extension files 509 that inherit from generic application services of GPROS to provide new specific and extended behaviors. This configuration data 507 and these service files 509, as well as existing GPROS configuration templates 513 and application services 517 may be used singularly or in combination by a GPROS application 515 to control a robot or autonomous vehicle 511.

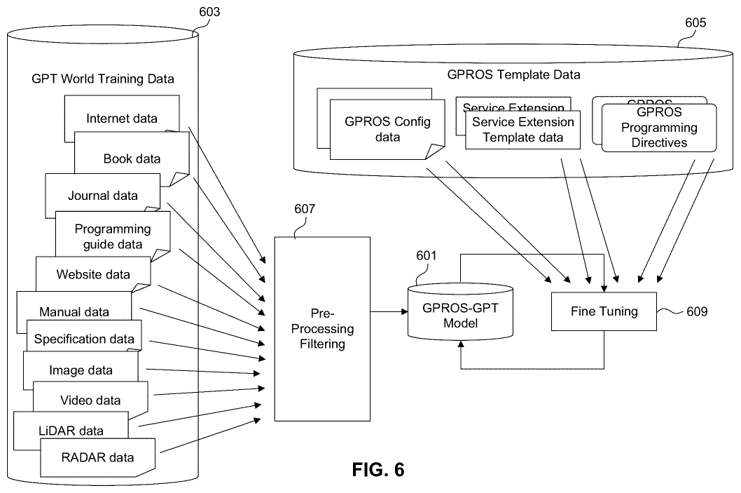

FIG. 6 illustrates a GPROS-GPT input data and model, according to some aspects. GPROS-GPT world training data 603 (similar to training data 503 of FIG. 5) comes from a diverse range of information sources. For example, the sources may include Internet text, books, articles, Websites, manuals, technical specifications, programming guides, and more (shown in FIG. 6). Additionally, or alternatively, GPROS-GPT world training data 603 can include other types of data. For example, GPROS-GPT world training data 603 can include raw sensor data that can include image data, video data, LiDAR point cloud data, RADAR data, and other forms of sensory information. According to some aspects, GPROS-GPT world training data 603 can include sensor information, which can include text data, Extensible Markup Language (XML) files, image data, video data, LiDAR point cloud data, RADAR data, and the like. The training data used may be on a massive order of magnitude of words (typically hundreds of billions or more words); may be on a massive order of image data from, for example, image sensors; may be on a massive order of video data from, for example, video sensors; may be on a massive order of LiDAR point cloud data, from, for example, LiDAR sensors, may be on a massive order of RADAR data from, for example, RADAR sensors. For example, GPROS-GPT world training data 603 may be from one or more sensors of one or more vehicles. Additionally, or alternatively, GPROS-GPT world training data 603 may be from one or more sensors stored in databases. GPROS-GPT world training data 603 may be preprocessed and cleaned to remove any potentially inaccurate content. Overall, the GPROS-GPT world training data 603 is extensive and diverse, allowing it to generate human-like responses to a wide range of questions and prompts.

GPROS template data 605 (similar to template data 505 of FIG. 5) comes from specific sources of information about GPROS. Sources include GPROS configuration file data, GPROS application service extension templates, directives for GPROS programming, and more (shown in FIG. 6). The template data used here can be inclusive of all GPROS configuration data files and templates, templates for creating application service extensions, directives that instruct how to generate and link GPROS configuration data, directives that define how to structure service extensions, and more. GPROS template data is used to fine-tune the GPT for specific tasks, which here involves generation of GPROS config data and service extension files. Ultimately, a resulting GPROS-GPT model is built from both the GPT World Training Data and GPROS Template Data.

FIG. 5 depicts a GPROS-GPT model 501 (which is similar to GPROS-GPT model 601 of FIG. 6). The GPT can be an existing GPT service, such as Open AI's GPT-3 or GPT-4, or Google's Bard. Such services provide application programmer interfaces (APIs) to access and interface with their underlying GPT architectures. The GPT may also be a custom-built architecture or an architecture modified based on an existing commercial or open-source platform. Irrespective of the underlying GPT architecture implementation, the model is trained with GPT World Training Data and also provided input with GPROS-GPT Template Data. As a result, the GPROS-GPT can be asked to produce GPROS config data and service extension files based on text-based requests and input.

GPROS config data files can be used with GPROS to configure new and existing application services. And GPROS service extension files can be used to implement new extensions to existing GPROS application services. This produces new GPROS behavior and operations based on GPT requests. The end result is to operate an autonomous vehicle or robot built with GPROS that realizes these new behaviors and operations in the physical world.

GPROS-GPT model 501 and/or 601 produces GPROS-based configurations and behaviors based on input requests referenced against underlying GPT World Training Data and GPROS Template Data. The requests are natural language-based commands requesting configurations and files that are used by GPROS to perform some action or produce some behavior from a robot or autonomous vehicle.

There are four phases to yielding these results:
a. Training Phase: The GPROS-GPT model 501 and/or 601 is trained with GPT World Training Data 503 and/or 603 and GPROS Template Data 505 and/or 605.
b. Query Phase: The GPROS-GPT model 501 and/or 601 is used to make requests for the generation of GPROS config data 507 and service extension files 509.
c. Loading Phase: The GPROS config data 507 and service extension files 509 are statically or dynamically loaded into a GPROS-based application 515.
d. Runtime Phase: The GPROS-based robot or autonomous vehicle application 515, which are configured with the config data, service extensions, and other GPROS config and application services are used to effect behavior in the physical world by the associated robot or autonomous vehicle.

### Training Phase

The training phase itself involves two main steps: pre-training (e.g., pre-processing filtering 607 of FIG. 6) and fine-tuning (e.g., fine tuning 609 of FIG. 6). During pre-training, the GPROS-GPT model is exposed to a large corpus of data from diverse sources. The data can include one or more of text data, Extensible Markup Language (XML) files, image data, video data, LiDAR point cloud data, or RADAR data. The data can include other types of sensor information. The text data can be from diverse sources, such as websites, books, articles, and other text documents. The image data, video data, LiDAR point cloud data, and/or RADAR data can be from diverse source, such as vehicle's sensors, other vehicles' sensors, one or more databases, and the like. The goal is to learn the statistical structure of the language and develop a general understanding of grammar, syntax, semantics, and common knowledge. During pre-training, GPROS-GPT is trained to predict the next word in a sentence given the context of the preceding words. This task, known as “masked language modeling” or “causal language modeling,” helps the model learn to generate coherent and contextually appropriate text. The model architecture consists of a multi-layer Transformer neural network with self-attention mechanisms, which allows it to process and learn from the relationships between words in the input data.

As the model goes through multiple iterations, or epochs, of the training data, it continually refines its internal weights and biases to minimize the prediction error. This unsupervised learning phase results in a “pre-trained” model that can generate text reasonably well but may not be specialized for specific tasks or domains.

After the pre-training step, the model undergoes a fine-tuning process. During this step, GPROS-GPT is trained on a smaller, more specific dataset that is relevant to the desired task or domain such as is the case with GPROS Template Data. The fine-tuning process involves supervised learning, where the model is provided with input-output pairs of examples related to the target task of generating GPROS config data and service extension files. These input-output pairs help the model learn the correct responses or actions for a given input. The fine-tuning process takes less time than the pre-training phase because the model has already learned general language patterns and knowledge.

During fine-tuning, the model's weights and biases are further refined to minimize the error on the specific task or domain. This process is often achieved by using techniques such as deep learning-based techniques such as gradient descent and backpropagation. The learning rate, or the step size in adjusting the model's parameters, is smaller in the fine-tuning phase to prevent overwriting the knowledge gained during pre-training.

Once the fine-tuning process with GPROS Template Data is complete, the model is ready for deployment and can be used to perform the target task with high accuracy and relevance. The combination of pre-training and fine-tuning allows GPT to generalize well on a wide range of language tasks while also being adaptable to specifically generating GPROS config data and service extension files based on requests.

### Query Phase

During the query phase, GPROS-GPT translates input requests into generated output using a sequence-to-sequence approach. The process involves tokenization, encoding, and decoding. The input text is first converted into a series of tokens, which are the smallest units of meaning in the text, such as words or sub-words
a. The tokenizer used by GPROS-GPT breaks the text into these tokens while maintaining the context and order of the words in the input.
b. Next, the tokens are mapped to unique integer IDs, which represent the tokens in the model's internal vocabulary. The integer IDs are then passed through an embedding layer that converts them into continuous vectors, which are more suitable for processing by a neural network.
c. The model then processes these input vectors using a multi-layer Transformer architecture with self-attention mechanisms. This allows the model to capture the relationships between tokens and their context within the input sequence. As the input passes through each layer of the Transformer, the model refines its understanding of the input and generates context-rich hidden states.
d. The generation of output begins with a special token, often called the start-of-sequence (SOS) token, which signals the model to start generating a response. GPROS-GPT uses a technique called autoregressive decoding, meaning it generates one token at a time based on the context of the previously generated tokens.

At each step, the model computes a probability distribution over its vocabulary for the next token, given the context of the input sequence and the tokens generated so far. The token with the highest probability, or a token sampled from the distribution, is then selected as the next token in the output sequence. This process of selecting the next token and updating the context continues until a predefined stopping criterion is met. This could be a specific end-of-sequence (EOS) token, a maximum length of the generated output, or a desired confidence threshold. Various decoding strategies, such as greedy search, beam search, or nucleus sampling, can be employed to balance the trade-off between output diversity and quality. Greedy search chooses the highest probability token at each step, while beam search maintains a fixed number of alternative sequences (beams) and chooses the one with the highest overall probability. Nucleus sampling involves sampling tokens from the top probability tokens that cumulatively make up a specified probability mass, such as 0.9, which encourages more diverse output.

Once the decoding process is complete, the generated output tokens are mapped back to their corresponding words or sub-words using the model's vocabulary and GPROS Template Data. These words or sub-words are then concatenated to form the final generated GPROS config data and service extension output text, which is the model's response to the input request.

For GPROS-GPT, the most optimal decoding strategy is typically beam search as it strikes a balance between exploration and exploitation in the generation process to produce specific GPROS config data and service extension formats, where the output should be both syntactically and semantically correct.

### Loading Phase

The GPROS config data and service extensions generated from one or more successive queries to GPROS-GPT are collected by GPROS developers and assembled as part of a GPROS configuration and application. The GPROS config data is placed into locations within GPROS config folders such that the GPROS config data can be loaded, statically or dynamically by a running GPROS application. References to the GPROS config files from other GPROS config files may also be made.

The GPROS service extension files are compiled and linked into a GPROS application either statically or dynamically. As GPROS provides a means to reference new service extension file names (e.g., see FIG. 3), a GPROS application can load the compiled service extension statically or dynamically. Once the output of GPROS-GPT requests are loaded into a GPROS application configuration as described above, the GPROS robotics or autonomous vehicle application is ready for runtime deployment.

### Runtime Phase

A robot or autonomous vehicle configured and loaded with a GPROS application configuration above, with embedded GPROS-GPT configurations and service extensions, is ready for deployment. Deployment involves positioning the robot or autonomous vehicle in the desired zone of operation and launching the GPROS-based application. Launching may involve pressing a start button, running a start script, or turning the ignition key on, among many other start-up methodologies. Once started the GPROS applications runs and operates the robot or autonomous vehicle. During this phase, the GPROS-GPT based configurations and service extensions are put to use in a physical world robotics or autonomous vehicle deployment.

### Representations

A set of representative uses of GPROS-GPT output from requests to the GPROS-GPT are listed here:
a. Config files with information or service extension files with instructions that GPROS uses to determine how to parse the sensor data from a specific make and model of sensor.
b. Config files with information or service extension files with instructions that GPROS uses to determine how to transform sensor data into detected objects in the physical world.
c. Config files with information or service extension files with instructions that GPROS uses to define how to plan a path for a robot or autonomous vehicle.
d. Config files with information or service extension files with instructions that GPROS uses to define new maneuvers and parameters for such maneuvers.
e. Config files with information or service extension files with instructions that GPROS uses to define what conditions trigger the active state for a maneuver of a robot or autonomous vehicle.
f. Config files with information or service extension files with instructions that GPROS uses to define collections of actions to take during a particular maneuver of a robot or autonomous vehicle.
g. Config files with information or service extension files with instructions that GPROS uses to define discrete action operations to take during a particular executed action of a robot or autonomous vehicle.
h. Config files with information or service extension files with instructions that GPROS uses to define parameterized conditions used to trigger action steps during a particular maneuver of a robot or autonomous vehicle.
i. Config files with information or service extension files with instructions that GPROS uses to determine how to translate the internal commands to output commands for control of an actuator, motor, or control system.
j. Config files with information or service extension files with instructions that GPROS uses to determine how to parse the communications data from a specific make and model of communications device and protocol.
k. Config files with information or service extension files with instructions that GPROS uses to determine how to translate the internal data to output messages for communications to a specific make and model of a communications device and protocol.
l. Config files with information or service extension files with instructions that GPROS uses to define new safety checking rules and parameters for such rules.
m. Config files with information or service extension files with instructions that GPROS uses to define new cybersecurity checking rules and parameters for such rules.
n. Config files with information or service extension files with instructions that GPROS uses to define new behaviors and parameters for such behaviors.

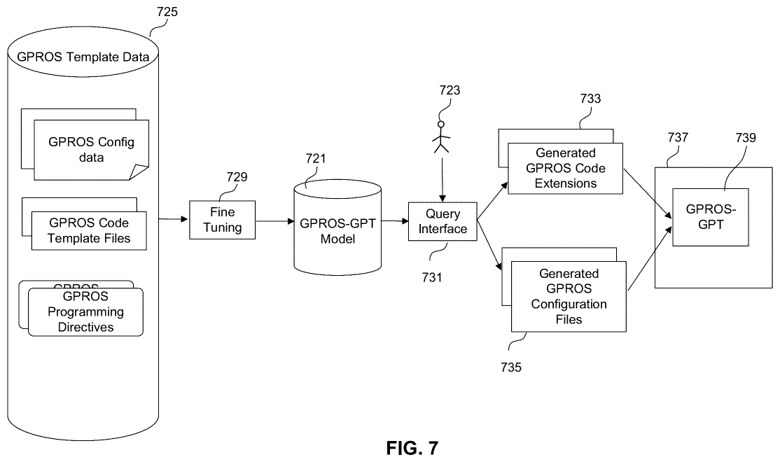

FIG. 7 illustrates another GPROS-GPT input data and model, according to some aspects.

Similar to FIG. 6, GPROS template data 725 (similar to template data 505 of FIG. 5 and/or GPROS template data 605 of FIG. 6) can be used for fine-tuning (e.g., fine tuning 729 of FIG. 7) of GPROS-GPT model 721. Fine tuning 729 can be similar to fine tuning 609 of FIG. 6. As discussed above, GPROS template data 725 can include generic modular building blocks of code for robotic & AVs and can be designed to be fed by configuration files for behavior and integration implementation.

Other training procedures (e.g., pre-processing filtering 607 of FIG. 6) can be used in addition to fine tuning 729 to train GPROS-GPT model 721. GPROS-GPT model 721 can be used for GPROS code and configuration generation.

According to some aspects, query interface 731 can be configured to receive one or more GPROS-GPT models from GPROS-GPT model 721. Also, query interface 731 can receive one or more queries from user 723. User 723 can be a GPROS-GPT copilot. According to some aspects, query interface 731 with GPROS-GPT model 721 can generate data for GPROS-GPT 739 based on queries for new behaviors and integrations based at least on the one or more GPROS-GPT models. In a non-limiting example, queries from user 723 can include, but is not limited to, “generate parallel parking maneuver,” “generate maneuver to platoon behind lead vehicle,” or the like.

According to some aspects, query interface 731 with GPROS-GPT model 721 can generate generated GPROS code extensions 733 and generated GPROS configuration files 735 based at least on the one or more GPROS-GPT models and/or the one or more queries from user 723. The generated GPROS code extensions 733 and generated GPROS configuration files 735 are uploaded to GPROS-GPT 739 in, for example, vehicle 737.

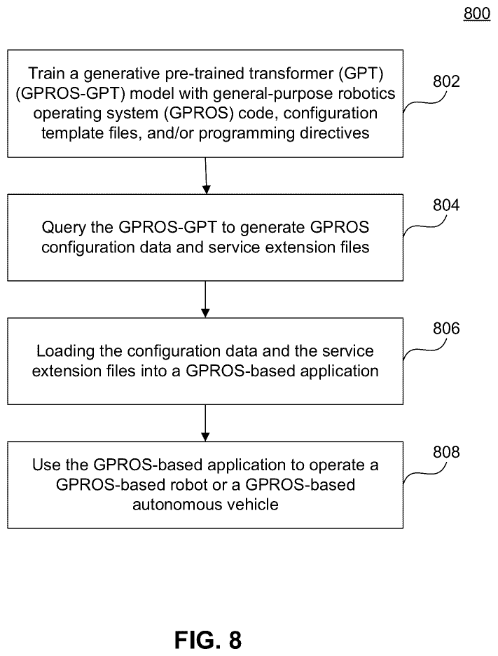

FIG. 8 is a flowchart for a method 800 for using the GPROS-GPT, according, according to some aspects. Method 800 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

A 802, a GPROS-GPT model is trained. For example, the GPROS-GPT model is trained with GPROS code and configuration template files and also with programming directives. In some aspects, the GPROS-GPT model is trained with GPROS code, configuration template files, and/or programming directives. According to some aspects, training the GPROS-GPT model can include a pre-training and a fine-tuning. For example, training the GPROS-GPT model can include training the GPROS-GPT model using data (e.g., text data, Extensible Markup Language (XML) files, image data, video data, LiDAR point cloud data, RADAR data, or the like) from a plurality of data sources and fine-tuning the trained GPROS-GPT model using a specific dataset corresponding to a task or a domain associated with GPROS template data. In some aspects, the training the GPROS-GPT model using the data (e.g., text data, Extensible Markup Language (XML) files, image data, video data, LiDAR point cloud data, RADAR data, or the like) includes an unsupervised training and the fine-tuning of the trained GPROS-GPT model includes a supervised training.

At 804, the GPROS-GPT model is queried to generate GPROS configuration data and service extension files. In some aspects, querying the GPROS-GPT includes receiving an input text and breaking the input text into a plurality of tokens while maintaining a context and order of words in the input text. Querying the GPROS-GPT can further include mapping the plurality of tokes into a plurality of unique integer identifiers (IDs) and converting the plurality of IDs to a plurality of continuous vectors. Querying the GPROS-GPT model can further include processing the plurality of continuous vectors using a multi-layer transformer architecture and generating the GPROS configuration data and service extension files based on the plurality of continuous vectors.

At 806, the configuration data and the service extension files are loaded into a GPROS-based application. In some aspects, loading the configuration data and the service extension files into the GPROS-based application can include collecting the configuration data and the service extension files generated from the querying the GPROS-GPT model. Further, loading the configuration data and the service extension files into the GPROS-based application can include storing the configuration data and the service extension files into GPROS configuration folders and compiling and linking the service extension files into the GPROS-based application. In some aspects, the compiling and linking the service extension files includes dynamically compiling and linking the service extension files. In some aspects, the compiling and linking the service extension files includes statically compiling and linking the service extension files.

At 808, the GPROS-based application is used to operate a GPROS-based robot or a GPROS-based autonomous vehicle. In some aspects, the using the GPROS-based application to operate the GPROS-based robot or the GPROS-based autonomous vehicle includes placing the GPROS-based robot or the GPROS-based autonomous vehicle in a zone of operation and launching the GPROS-based application to use the configuration data and the service extension files.

### Example Computer System

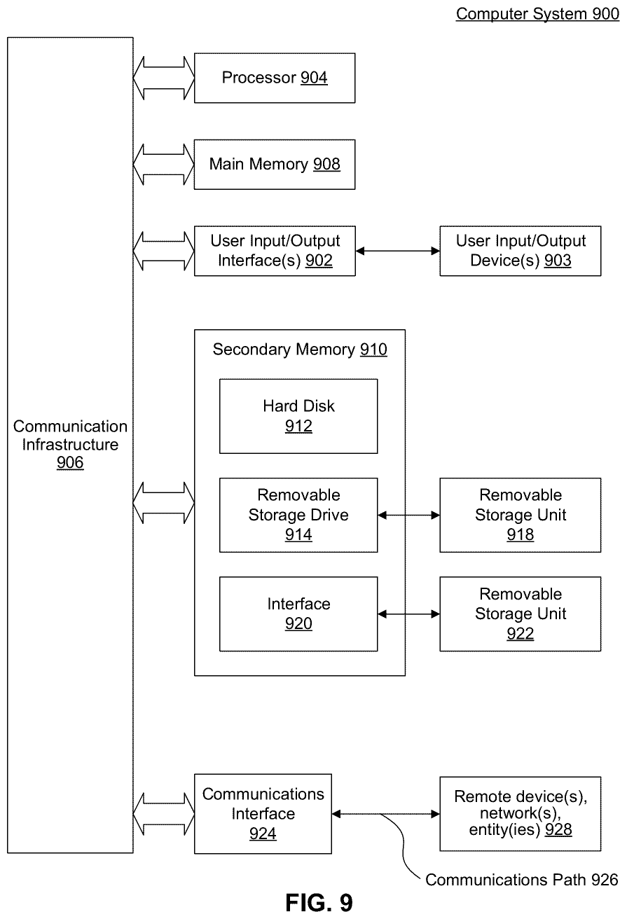

Various aspects may be implemented, for example, using one or more computer systems, such as computer system 900 shown in FIG. 9. Also or alternatively, one or more computer systems 900 may be used, for example, to implement any of the aspects discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (0), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900 or processor(s) 904), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 9. In particular, aspects can operate with software, hardware, and/or operating system implementations other than those described herein.

### CONCLUSION

While the invention has been described herein with reference to exemplary aspects for exemplary fields and applications, it should be understood that the invention is not limited thereto. Other aspects and modifications thereto are possible, and are within the scope and spirit of the invention. For example, and without limiting the generality of this paragraph, aspects are not limited to the software, hardware, firmware, and/or entities illustrated in the figures and/or described herein. As another example, a drive system may be described that may be an electric drive system or one with an internal combustion engine; use of one drive system should not be read to preclude another drive system. Further, aspects (whether or not explicitly described herein) have significant utility to fields and applications beyond the examples described herein.

Aspects have been described herein with the aid of functional building blocks (e.g., modules or cartridges) illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects may perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

What is claimed is:

1. A method of using a general-purpose robotics operating system (GPROS) with generative pre-trained transformers (GPT) (GPROS-GPT) model, the method comprising:
training the GPROS-GPT model;
querying the GPROS-GPT model to generate GPROS configuration data and service extension files;
loading the configuration data and the service extension files into a GPROS-based application; and
using the GPROS-based application to operate a GPROS-based robot or a GPROS-based autonomous vehicle.

2. The method of claim 1, wherein the training the GPROS-GPT model further comprises:
training the GPROS-GPT model using data from a plurality of data sources, wherein the data comprises one or more of text data, Extensible Markup Language (XML) files, image data, video data, LiDAR point cloud data, or RADAR data; and
fine-tuning the trained GPROS-GPT model using a specific dataset corresponding to a task or a domain associated with GPROS template data.

3. The method of claim 2, wherein the training the GPROS-GPT model using the text data comprises an unsupervised training and the fine-tuning of the trained GPROS-GPT model comprises a supervised training.

4. The method of claim 1, wherein the querying the GPROS-GPT model comprises:
receiving an input text;
breaking the input text into a plurality of tokens while maintaining a context and order of words in the input text;
mapping the plurality of tokes into a plurality of unique integer identifiers (IDs);
converting the plurality of IDs to a plurality of continuous vectors;
processing the plurality of continuous vectors using a multi-layer transformer architecture; and
generating the GPROS configuration data and service extension files based on the plurality of continuous vectors.

5. The method of claim 1, wherein the loading the configuration data and the service extension files into the GPROS-based application comprises:
collecting the configuration data and the service extension files generated from the querying the GPROS-GPT model;
storing the configuration data and the service extension files into GPROS configuration folders; and
compiling and linking the service extension files into the GPROS-based application.

6. The method of claim 5, wherein the compiling and linking the service extension files comprises dynamically compiling and linking the service extension files.

7. The method of claim 1, wherein the using the GPROS-based application to operate the GPROS-based robot or the GPROS-based autonomous vehicle comprises:
placing the GPROS-based robot or the GPROS-based autonomous vehicle in a zone of operation; and
launching the GPROS-based application to use the configuration data and the service extension files.

8. A non-transitory computer-readable medium storing instructions that, when executed by a processor, cause the processor to perform operations, comprising:
training a general-purpose robotics operating system (GPROS) with generative pre-trained transformers (GPT) (GPROS-GPT) model;
querying the GPROS-GPT model to generate GPROS configuration data and service extension files;
loading the configuration data and the service extension files into a GPROS-based application; and
using the GPROS-based application to operate a GPROS-based robot or a GPROS-based autonomous vehicle.

9. The non-transitory computer-readable medium of claim 8, wherein the training the GPROS-GPT model further comprises:
training the GPROS-GPT model using data from a plurality of data sources, wherein the data comprises one or more of text data, Extensible Markup Language (XML) files, image data, video data, LiDAR point cloud data, or RADAR data; and
fine-tuning the trained GPROS-GPT model using a specific dataset corresponding to a task or a domain associated with GPROS template data.

10. The non-transitory computer-readable medium of claim 9, wherein the training the GPROS-GPT model using the text data comprises an unsupervised training and the fine-tuning of the trained GPROS-GPT model comprises a supervised training.

11. The non-transitory computer-readable medium of claim 8, wherein the querying the GPROS-GPT model comprises:
receiving an input text;
breaking the input text into a plurality of tokens while maintaining a context and order of words in the input text;
mapping the plurality of tokes into a plurality of unique integer identifiers (IDs);
converting the plurality of IDs to a plurality of continuous vectors;
processing the plurality of continuous vectors using a multi-layer transformer architecture; and
generating the GPROS configuration data and service extension files based on the plurality of continuous vectors.

12. The non-transitory computer-readable medium of claim 8, wherein the loading the configuration data and the service extension files into the GPROS-based application comprises:
collecting the configuration data and the service extension files generated from the querying the GPROS-GPT model;
storing the configuration data and the service extension files into GPROS configuration folders; and
compiling and linking the service extension files into the GPROS-based application.

13. The non-transitory computer-readable medium of claim 12, wherein the compiling and linking the service extension files comprises dynamically compiling and linking the service extension files.

14. The non-transitory computer-readable medium of claim 8, wherein the using the GPROS-based application to operate the GPROS-based robot or the GPROS-based autonomous vehicle comprises:
placing the GPROS-based robot or the GPROS-based autonomous vehicle in a zone of operation; and
launching the GPROS-based application to use the configuration data and the service extension files.

15. A computing system comprising:
one or more memories; and
at least one processor each coupled to at least one of the one or more memories, wherein the at least one processor is configured to:
train a general-purpose robotics operating system (GPROS) with generative pre-trained transformers (GPT) (GPROS-GPT) model;
query the GPROS-GPT model to generate GPROS configuration data and service extension files;
load the configuration data and the service extension files into a GPROS-based application; and
use the GPROS-based application to operate a GPROS-based robot or a GPROS-based autonomous vehicle.

16. The computing system of claim 15, wherein to train the GPROS-GPT, the at least one processor is configured to:
train the GPROS-GPT model using data from a plurality of data sources, wherein the data comprises one or more of text data, Extensible Markup Language (XML) files, image data, video data, LiDAR point cloud data, or RADAR data; and
fine-tune the trained GPROS-GPT model using a specific dataset corresponding to a task or a domain associated with GPROS template data.

17. The computing system of claim 15, wherein to query the GPROS-GPT model, the at least one processor is configured to:
receive an input text;
break the input text into a plurality of tokens while maintaining a context and order of words in the input text;
map the plurality of tokes into a plurality of unique integer identifiers (IDs);
convert the plurality of IDs to a plurality of continuous vectors;
process the plurality of continuous vectors using a multi-layer transformer architecture; and
generate the GPROS configuration data and service extension files based on the plurality of continuous vectors.

18. The computing system of claim 15, wherein to load the configuration data and the service extension files into the GPROS-based application, the at least one processor is configured to:
collect the configuration data and the service extension files generated from the querying the GPROS-GPT model;
store the configuration data and the service extension files into GPROS configuration folders; and
compile and link the service extension files into the GPROS-based application.

19. The computing system of claim 16, wherein to compile and link the service extension files, the at least one processor is configured to dynamically compile and link the service extension files.

20. The computing system of claim 15, wherein to use the GPROS-based application to operate the GPROS-based robot or the GPROS-based autonomous vehicle, the at least one processor is configured to:
launch the GPROS-based application to use the configuration data and the service extension files, wherein the GPROS-based robot or the GPROS-based autonomous vehicle is placed in a zone of operation.
